(19) United States
(12) Patent Application Publication
(10) Pub. No.: US 2025/0361922 A1
(43) Pub. Date: Nov. 27, 2025

(54) WEDGE CLAMP AND TENSIONING DEVICE WITH SUCH A WEDGE CLAMP

(71) Applicant: Richard Bergner Holding GmbH & Co. KG, Schwabach (DE)

(72) Inventor: Simon ZEMKE, Rednitzhembach (DE)

(21) Appl. No.: 19/295,895

(22) Filed: Aug. 11, 2025

Related U.S. Application Data
(63) Continuation of application No. PCT/EP2024/052810, filed on Feb. 5, 2024.

(30) Foreign Application Priority Data
Feb. 10, 2023 (DE) 10 2023 201 106.9

(51) Int. Cl. F16G 11/10; H02G 1/04

(52) U.S. Cl. CPC F16G 11/105; H02G 1/04

(57) ABSTRACT

A wedge clamp for a rope includes two clamping wedges extending in a longitudinal direction. The clamping wedges are accommodated in a clamping housing in an assembled state. The clamping wedges have a channel extending in the longitudinal direction for clampingly receiving the rope. A groove extending in the longitudinal direction is provided in the channel. The groove is preferably used to adjust transverse compressive forces during tensioning, so that the wedge clamp is also suitable for ropes with a pressure-sensitive core. A tensioning device for tensioning a rope is also provided.

### CROSS-REFERENCE TO RELATED APPLICATION

This application is a continuation, under 35 U.S.C. § 120, of copending International Patent Application PCT/EP2024/052810, filed Feb. 5, 2024, which designated the United States; this application also claims the priority, under 35 U.S.C. § 119, of German Patent Application DE 10 2023 201 106.9, filed Feb. 10, 2023; the prior applications are herewith incorporated by reference in their entirety.

### FIELD AND BACKGROUND OF THE INVENTION

The invention relates to a wedge clamp and a tensioning device with such a wedge clamp.

Wedge clamps are used in tensioning devices for tensioning ropes, in particular conductor ropes in overhead electrical lines. For that purpose, the wedge clamp has two clamping wedges extending in a longitudinal direction, which are accommodated in a clamping housing. When the rope is subjected to a tensile load, the wedge shape creates a self-clamping effect so that the rope is reliably clamped. The basic configuration of such wedge-type tension clamps is described, for example, in European Patent EP 1 255 339 B1, German Application DE 40 19 999 A1 and Austrian Patent AT 224183 B.

Such wedge clamps provide reliable clamping with a high clamping force. The clamping wedges exert high transverse forces on the rope from two directions, so that a deformation or ovalization of the rope to be clamped typically occurs.

However, wedge clamps of that type are not suitable for ropes with pressure-sensitive cores, where the pressure-sensitive core is a central tension-resistant strand made of carbon fibers and/or glass fibers, for example. When using a conventional wedge clamp, there is a risk that the pressure-sensitive core will deform or be damaged under heterogeneous radial compressive stress (shear force primarily from two directions from the two clamping wedges) and, for example, tear or break axially.

Chinese Publication CN 201041930 Y also shows a tension clamp with a different clamping concept. A slotted clamping sleeve is provided, into which a fastening hook is screwed at the end, through the use of which axial displacement is achieved. In that configuration, the clamping force is exerted by elastic deformation of the individual sections of the slotted sleeve-in contrast to the wedge clamps with the two dimensionally stable clamping wedges. However, the manufacture and assembly of such a slotted sleeve is complex.

### SUMMARY OF THE INVENTION

It is accordingly an object of the invention to provide a wedge clamp and a tensioning device with such a wedge clamp, which overcome the hereinafore-mentioned disadvantages of the heretofore-known devices of this general type and which enable a reliable tensioning of a rope with a pressure-sensitive core at low cost and low assembly effort.

With the foregoing and other objects in view there is provided, in accordance with the invention, a wedge clamp for a rope and a tensioning device with such a wedge clamp. The wedge clamp has two clamping wedges extending in a longitudinal direction, each of which is an independent structural unit. The clamping wedges taper in a wedge shape in the longitudinal direction. When mounted, the two clamping wedges are held in a clamping housing. The clamping housing has a receptacle for the clamping wedges, which is usually also wedge-shaped in the longitudinal direction. The clamping wedges also have a channel extending in the longitudinal direction, in which the rope to be clamped lies in the assembled state. A groove extending in the longitudinal direction is now provided in this channel. In the tensioning device, the rope lies in this wedge clamp and is reliably clamped.

The additional groove in the channel is particularly important for the reliable and gentle clamping of a rope with a pressure-sensitive core. Studies have shown that the groove in the bottom of the channel has a beneficial effect on the radial clamping forces, particularly on the core, so that the (transverse) compressive stress on the pressure-sensitive core is significantly homogenized radially compared to a conventional wedge clamp without such a groove. This effect is sufficiently large to ensure that the pressure-sensitive core is not damaged while the rope is clamped reliably and securely. The pressure zones on the rope and also on the core can be set in a defined manner by a specific configuration of the groove.

In order to avoid any pressure zones, the entire clamping region and the channels in particular have a homogeneous configuration. This means that the respective channel has a continuously smooth surface over the entire length of at least the clamping region. In particular, the channels are free of radially protruding ribs, especially those running transversely to the longitudinal direction.

The two clamping wedges are generally two separate components, each of which has the channel with the groove formed in it. The components have a sufficiently high inherent rigidity so that—unlike a slotted sleeve—they are dimensionally stable even when the rope is clamped and do not deform elastically. Due to their wedge-shaped configuration, the two clamping wedges are only displaced against each other in a radial direction in order to exert the clamping force.

All in all, this ensures the usual simple installation of the rope with a simple configuration similar to conventional wedge clamps. At the same time, the groove makes it possible to clamp ropes with pressure-sensitive cores.

Insofar as the term groove is used in the present case, this refers to a material recess extending in the longitudinal direction within a base body and in the wall of the clamping wedge without penetrating this wall. This means that a respective groove has a groove base which is formed by the base body of a respective clamping wedge.

A respective groove extends over the entire length of the clamping wedge, at least over the length of a clamping region. A respective groove therefore runs freely at the opposite ends of the clamping region and in particular at opposite end faces of the clamping wedge. The clamping region is defined by the area in which the rope is clamped between the two clamping wedges in the assembled state and these therefore exert a clamping force on the rope.

The two clamping wedges have an identical configuration, at least when viewed in cross-section over the clamping region. Preferably, at least the contour directed towards the rope structure to be clamped, i.e. the contour gripping the rope, is identical.

A respective clamping wedge is a one-piece, in particular monolithic component, at least in the area of the conductor rope to be clamped. A respective channel has a wall formed by the clamping wedge, which, when viewed in cross-section, preferably runs along an arc of a circle that has a predetermined clamping radius.

The groove therefore extends over the entire length of at least the clamping region and, furthermore, a profile cross-section formed by the channel and by the groove—at least one cross-sectional contour facing the rope—is constant over this entire length of the clamping wedge or at least the clamping region. In other words, the cross-sectional contour of the groove and the cross-sectional contour of the channel, i.e. its course on the side facing the rope (curvature, width of the channel, depth of the channel), are constant over the entire length. This ensures a homogeneous, equal pressure load over the entire clamping region and avoids undesirable, localized pressure zones or pressure peaks.

In a preferred embodiment, the clamping radius corresponds to an outer radius of a rope structure of the rope to be clamped. A clamping diameter (double clamping radius) is typically in the range of 10 mm to 60 mm. Depending on the configuration, the outer radius of the rope structure is defined, for example, by the rope itself or, for example, by the rope plus a protective spiral surrounding it. This also favors a homogeneous pressure distribution and avoids local pressure zones or pressure peaks.

The channel has a radial depth that is one gap smaller than the clamping radius. If the two clamping wedges are in contact with the rope structure, the two clamping wedges are therefore spaced apart by twice the gap dimension.

The groove itself is limited by the groove base and two opposing groove walls. Each groove has a groove depth and a groove width. The groove depth is always less than the wall thickness of the clamping wedges and in particular less than half and preferably less than ¼ of the wall thickness of the clamping wedge, based on its thickest area.

Groove depth is the distance in the radial/vertical direction between the circular arc running along the wall of the channel and the groove base. The groove width is the distance between the two groove walls perpendicular to a radial/perpendicular to the vertical direction at half the height of the groove depth.

According to a preferred embodiment, the groove width is in the range between 0.5 times and five times the gap dimension between the mounted clamping wedges and in particular in the range between one and three times the gap dimension, especially twice the gap dimension.

Preferably, the groove depth is between 0.5 and 1.5 times the groove width and, in particular, up to a maximum of one time the groove width. Preferably, the groove depth is about ⅔ of the groove width.

In a preferred embodiment, the overall groove depth is smaller than the groove width.

Studies have shown that such dimensions are particularly useful for the desired distribution of transverse compressive forces in order to reliably protect the pressure-sensitive core.

Preferably, the groove merges rounded into the wall of the channel. The groove walls therefore have a transition radius in particular, which merges into the clamping radius. This avoids a sharp-edged transition overall.

The cross-sectional contour of the groove is preferably approximately rectangular, alternatively it can also be circular or polygonal, e.g. triangular. It is important that the groove is wide enough and preferably has a rounded transition into the wall.

In addition, a rounded transition is preferably also formed between the groove base and the groove walls. The transitions from the groove base to the groove walls on the one hand and from the groove walls into the wall of the channel on the other hand have the same radius, for example. Preferably, the groove walls-viewed in cross-section-run continuously curved along curved lines and thus, for example, in an S-shape from the groove base into the wall. The groove base preferably runs in a straight line.

The groove width preferably widens from the groove base in the direction to the channel. The lateral groove walls are therefore preferably inclined. The two groove walls therefore do not run parallel to each other and include a groove angle between them. This is preferably in a range between 30°-50° and in particular around 40°. This measure ensures a smooth and even transition into the wall of the channel and thus a suitable transverse pressure load.

The rope held by the tensioning device is in particular a rope with a pressure-sensitive core, in particular a carbon core or a glass fiber core. This is understood to mean that the core is formed of preferably a large number of individual non-metallic fibers, in particular carbon fibers and/or glass fibers. These are typically embedded in a matrix. This core forms a central tensile strand. Several layers of rope strands are typically stranded around this core. These rope strands are typically in the form of aluminum rope strands.

In a preferred embodiment, a protective spiral is also fitted around the rope. This preferably only extends in the area of the wedge clamp, i.e. has a length that is, for example, between twice or even three times the length of the wedge clamp. However, the protective spiral extends at least over both ends of the clamping wedges, preferably over the length of the clamping region (length of the clamping wedges). A curved rope guide, also known as an outgoing, is typically attached to one of the two clamping wedges. The protective spiral preferably extends at least over this rope guide. The protective spiral is formed of at least one and, if necessary, several rods wound spirally around the rope. These rods are preferably made of aluminum. The rope together with the protective spiral forms the rope structure to be clamped. In embodiments without a protective spiral, the rope diameter and thus the clamping diameter of the clamping wedges is typically in the range from 10 mm to 50 mm and in embodiments with a protective spiral, the corresponding diameter is typically in the range from 15 mm to 60 mm.

Other features which are considered as characteristic for the invention are set forth in the appended claims.

Although the invention is illustrated and described herein as embodied in a wedge clamp and a tensioning device with such a wedge clamp, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a lateral representation in the form of a longitudinal section of a tensioning device with a wedge clamp and a rope with a pressure-sensitive core held therein;

FIG. 2 is a top view of a clamping wedge;

FIG. 3 is an end view of the clamping wedge shown in FIG. 2; and

FIG. 4 is an enlarged view of the area marked with a circle A in FIG. 3.

### DETAILED DESCRIPTION OF THE INVENTION

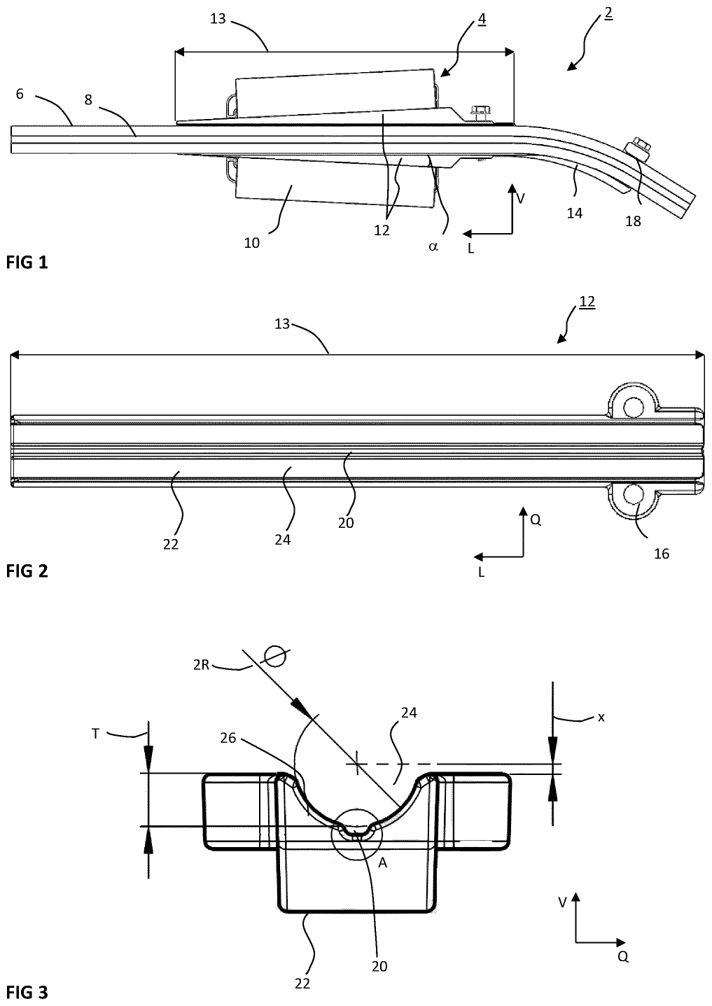

Referring now to the figures of the drawings in detail and first, particularly, to FIG. 1 thereof, there is seen a tensioning device 2 which has a wedge clamp 4 with a rope 6 clamped therein. The rope 6 has a pressure-sensitive core 8, for example in the form of a carbon core. Several metallic rope strands are stranded around this core in one or more layers.

The wedge clamp 4 extends in a longitudinal direction L and has a clamping housing 10 in which two clamping wedges 12 are accommodated. The wedge clamp 4 is usually made of metal, for example aluminum. The basic structure of such wedge clamps 4 is known. For example, the clamping housing 10 has two side parts and a housing base so that it is U-shaped in cross-section and the rope 6 can be inserted from the side. Once the rope 6 has been inserted, the clamping housing 10 is closed by a housing cover. The housing cover and housing base are configured in particular like profile rails, which can be inserted in the longitudinal direction into a corresponding profile structure of the side parts. The clamping housing 10 defines a free interior, which is wedge-shaped in the longitudinal direction. This is achieved in particular by a wedge-shaped configuration of the profile rails.

As can be seen in particular from FIG. 1, the two clamping wedges 12 are wedge-shaped when viewed from the side. The outer sides of a respective clamping wedge 12, which are opposite in the vertical direction, rise in a wedge shape at a wedge angle α and rest against a corresponding inclined wall of the clamping housing 10. This is formed by the profile rails.

The two clamping wedges 12 define a clamping region 13, within which they exert a radial clamping force on the rope 6. The clamping region extends over the entire length of the clamping wedges 12. A curved rope guide 14 is usually attached to one of the two clamping wedges 12, in the example shown in the lower half of the image, which together with the clamping wedge 12 can form a (monolithic) component. In the present case, clamping wedge 12 (only) refers to the wedge-shaped area in which the opposing outer sides run at the wedge angle α to each other. The two clamping wedges 12 are connected to each other at the rear edge of the clamping region 13. For this purpose, each clamping wedge 12 has widenings 16 with through-holes so that a type of clamp is formed. A further screw clamp 18 is attached to the end of the curved rope guide 14 to fix the rope 6 to the curved rope guide 14.

Protruding fastening pins (not shown in the figures) are attached to the clamping housing 10, to which suspension lugs are attached, with which the wedge-type guy clamp 4 is suspended from a mast of the overhead line. The rope 6 is generally a conductor rope of an overhead line for transmitting electricity. Accordingly, the tensioning device 2 is mounted on a (tensioning) mast of such an overhead line in the assembled state.

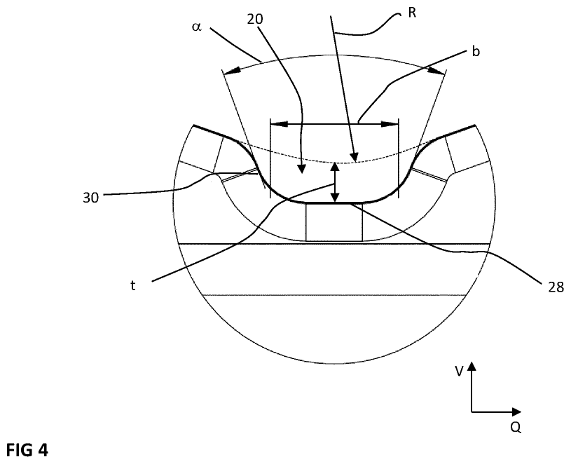

In order to be able to clamp a rope 6 with a pressure-sensitive core 8 without the risk of damaging the pressure-sensitive core 8 with a wedge clamp 4 of this type, the clamping wedges 12 are each provided with a groove 20, as explained in more detail in connection with FIGS. 2 to 4. FIG. 2 shows a top view of the clamping wedge 12 without the rope guide 14, FIG. 3 shows a view in the longitudinal direction L of the rear end face of the clamping wedge 12 and FIG. 4 shows an enlarged view of the area marked with the circle A in FIG. 3.

The respective clamping wedge 12 extends in the longitudinal direction L, in the transverse direction Q and in the vertical direction V, whereby these three directions form a Cartesian coordinate system. The respective clamping wedge 12 has a particularly monolithic base body 22 with a top side, a bottom side and two side surfaces. The base body 22 has a channel 24 on the upper side, which extends in the longitudinal direction L over the entire length of the clamping region 13 and in particular over the entire length of the clamping wedge 12. This channel 24 has a wall 26 as the channel base, which runs along an arc of a circle with a clamping radius R. The base body 22 typically has a rectangular cross-sectional shape-except for the channel 24 with the groove 22—and the side surfaces therefore run parallel to each other.

The clamping radius R corresponds in particular to a radius of the rope structure to be clamped. This clamping radius R may be given by the radius of the rope 6 itself. Alternatively, in an embodiment in which a protective spiral (not shown herein) is fitted around the rope 6 at least in the clamping region, the clamping radius R corresponds to the radius of the rope structure to be clamped, formed of the rope 6 and the protective spiral.

The channel 24 has a radial depth T, which is smaller than the clamping radius R by a gap dimension x. When the rope 6 is inserted, the two clamping wedges 12 are therefore spaced apart by twice the gap dimension x at their parting plane. The radial depth T is defined by the distance in the radial direction/vertical direction V between the upper side of the clamping wedge 12 and the deepest point of the channel 24 without taking the groove 20 into account (see also FIG. 3).

As can be seen in particular from FIG. 4, the groove 20 has a groove base 28 and two lateral groove walls 30. The groove 20 has a groove depth t and a groove width b. The groove depth t is the distance in the radial direction/vertical direction V between the imaginary arc line of the clamping radius R and the groove base 28. The groove width b is the distance between the two groove walls 30 in the transverse direction Q at the level of half the groove depth t.

The groove depth t is generally smaller than the groove width b in particular. In particular, it lies, for example, in the range between 0.25 times and 0.75 times the groove width b. In the embodiment example, it is in particular around ½ of the groove width b.

Furthermore, the groove width b is in the range between one and three times the gap dimension x. In the embodiment example, the groove width b is in particular twice the gap dimension x. The groove width b therefore preferably corresponds to the distance between the two clamping wedges 12.

The groove depth t generally corresponds to only a fraction of the total wall thickness of the clamping wedge 12 in the vertical direction V, namely at the rear, widest end of the clamping wedge 12. The wall thickness of the clamping wedge 12 at this rear end is, for example, 25 mm to 35 mm.

As can also be clearly seen from FIG. 4, the groove 20 does not have any sharp-edged transitions when viewed in cross-section. In particular, the groove walls 30 merge into the wall 26 of the channel 24, forming a rounded section. The groove base 28 also merges into the groove walls 30 in a rounded manner.

The groove width b thus widens starting from the groove base 28. The groove walls 30 are orientated at an angle to each other and enclose a groove angle α between them. This is, for example, in the range between 25 and 60° and in the embodiment example in particular at 40°.

The wedge angle α of the respective clamping wedge 12, i.e. the angle at which the opposing boundary sides (upper side and lower side) of the respective clamping wedge 12 extend relative to one another, is typically in the range of a few degrees, for example in the range of 1°-6° and in the embodiment example at around 2° to 4°, in particular at 3°. The clamping wedges 12 (without the rope guide 14) typically have a length in the longitudinal direction L of, for example, 25 cm to 40 cm and in the embodiment example in the range of 30 cm. The width of the clamping wedges 12 in the transverse direction Q (without the widenings 16) is, for example, in the range between 3 cm and 8 cm and in particular in the range of 5 cm.

The following is a summary list of reference numerals and the corresponding structure used in the above description of the invention:
2 tensioning device
4 wedge clamp
6 rope
8 pressure-sensitive core
10 clamping housing
12 clamping wedge
13 clamping region
14 rope guides
16 widening
18 screw clamp
20 groove
22 base body
24 channel
26 wall
28 groove base
30 groove wall
L longitudinal direction
Q transverse direction
V vertical direction
R clamping radius
X gap dimension
T radial depth of the channel
t groove depth
b groove width
α groove angle

1. A wedge clamp for a rope, the wedge clamp comprising:
a clamping housing;
two clamping wedges extending in a longitudinal direction, said clamping wedges being accommodated in said clamping housing in an assembled state;
said clamping wedges defining a clamping region within which said clamping wedges exert a radial clamping force on the rope in said assembled state, said clamping region having a length;
said clamping wedges having a channel extending in the longitudinal direction for clampingly receiving the rope;
said channel having a groove extending in the longitudinal direction, said groove extending continuously and entirely over said length of at least said clamping region; and
said channel and said groove forming a cross-sectional contour facing the cable to be clamped, said cross-sectional contour being constant entirely over said length of at least said clamping region.

2. The wedge clamp according to claim 1, wherein said channel has a wall running along an arc of a circle with a predetermined clamping radius, said predetermined clamping radius corresponding to a radius of a rope structure of the rope to be clamped.

3. The wedge clamp according to claim 2, wherein said channel has a depth being less than said predetermined clamping radius by a gap dimension, and said groove has a groove depth and a groove width.

4. The wedge clamp according to claim 3, wherein said groove width is in a range between 0.5 times and five times said gap dimension.

5. The wedge clamp according to claim 3, wherein said groove width is in a range between one and three times said gap dimension.

6. The wedge clamp according to claim 3, wherein said groove depth is in a range between 0.5 times and 1.5 times said groove width.

7. The wedge clamp according to claim 3, wherein said groove depth is in a range of up to a maximum of one time said groove width.

8. The wedge clamp according to claim 3, wherein said groove depth is smaller than said groove width.

9. The wedge clamp according to claim 1, wherein said channel has a wall, and said groove merges rounded into said wall of said channel.

10. The wedge clamp according to claim 1, wherein said groove has a groove base and two lateral, inclined groove walls, causing said groove to widen starting from said groove base.

11. A tensioning device for tensioning a rope, the tensioning device comprising a wedge clamp according to claim 1 and a rope clamped in the wedge clamp.

12. The tensioning device according to claim 11, wherein the rope has a pressure-sensitive core.

13. The tensioning device according to claim 12, wherein said pressure-sensitive core is a carbon core.

14. The tensioning device according to claim 12, which further comprises a protective spiral provided around the rope in a region of the wedge clamp.
